(19) United States
(12) Patent Application Publication
(10) Pub. No.: US 2006/0014131 A1
(43) Pub. Date: Jan. 19, 2006

(54) Dynamically developing education plans utilizing user preferences and/or constraints

(75) Inventor: Jennifer Bigus, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/892,452

(22) Filed: Jul. 15, 2004

(51) Int. Cl. G09B 7/00

(52) U.S. Cl. 434/362

(57) ABSTRACT

A computer-implemented method, system and computer product including a planning manager residing in memory; whereby the planning manager dynamically develops education plans employing user preferences and/or constraints.

### BACKGROUND OF THE INVENTION

The present invention relates generally to methods, systems, and computer program products for dynamically developing education plans based on user preferences and/or constraints.

Companies and education facilities invest significant sums of money, manpower, and time to provide a vast wealth of training resources in order that their employees, students, and customers may obtain necessary skills and training. Often users develop individual roadmaps or education plans aimed at acquiring the desired knowledge base. Typically, such resources may include web sites defining learning services, technical supports, books, periodicals, tutorials, and more. Because of the widespread and diverse nature of these education resources, it may be difficult to efficiently and economically map such plans. Moreover, updating the plans is often problematic considering that the resources are subject to changes.

Known approaches for developing roadmaps are inherently time consuming given that a user must statically assess a significant number of resources according to relevance to education goal(s) of the user. Consequently, it is difficult to efficiently and effectively generate and/or maintain user's education plans, particularly in an environment wherein education resources continuously change.

Presently, there are no known approaches which do this dynamically; especially in a manner responsive to users' preferences and/or constraints. Moreover, there are no known approaches for users being able to dynamically update educational plans once generated. This is a problem given the ongoing changes generally being made.

Without these needs being satisfied, the true potential for developing individualized education plans is less than entirely satisfied.

### SUMMARY OF THE INVENTION

The present invention provides enhanced methods, systems, and computer program products for dynamically developing education plans responsive to user preferences and/or constraints without negative effect and that overcome many of the disadvantages of the prior art.

The present invention provides improvements in methods, systems, and computer program products for dynamically developing education plans responsive to user preferences and/or constraints utilizing an inference engine for developing education plans based on retrieved data.

The present invention provides improvements in methods, systems, and computer program products for dynamically developing education plans including a planning rule base coupled to the inference engine for use in inferencing, whereby the retrieved data includes education domain data and user profile data, to thereby return an education plan.

The present invention provides improvements in methods, systems, and computer program products for dynamically developing education plans including profiling agents which obtain specific information about users for use in generating such plans.

The present invention provides improvements in methods, systems, and computer program products for dynamically developing education plans including use of domain agents which mine databases for current education offerings.

The present invention provides improvements in methods, systems, and computer program products for dynamically developing education plans in which a profiling agent monitors users for learning unstated preferences of the users.

These and other features and aspects of the present invention will be more fully understood from the following detailed description of the preferred embodiments, which should be read in light of the accompanying drawings. It should be understood that both the foregoing generalized description and the following detailed description are exemplary, and are not restrictive of the invention.

### BRIEF DESCRIPTION OF THE DRAWINGS

FIG. 1 is a block diagram illustrating an environment in which the present invention functions. )

FIG. 2 is a block diagram of a computer system in accordance with one of the preferred embodiments.

FIG. 3 is a block diagram illustrating components of the present invention for use in returning individualized education plans.

FIGS. 4A & 4B represent exemplary flow diagrams illustrating the development of education plans in accordance with the present invention.

### DETAILED DESCRIPTION

The present invention provides enhanced methods, systems, and computer program products for dynamically developing education plans responsive to the preferences and/or constraints.

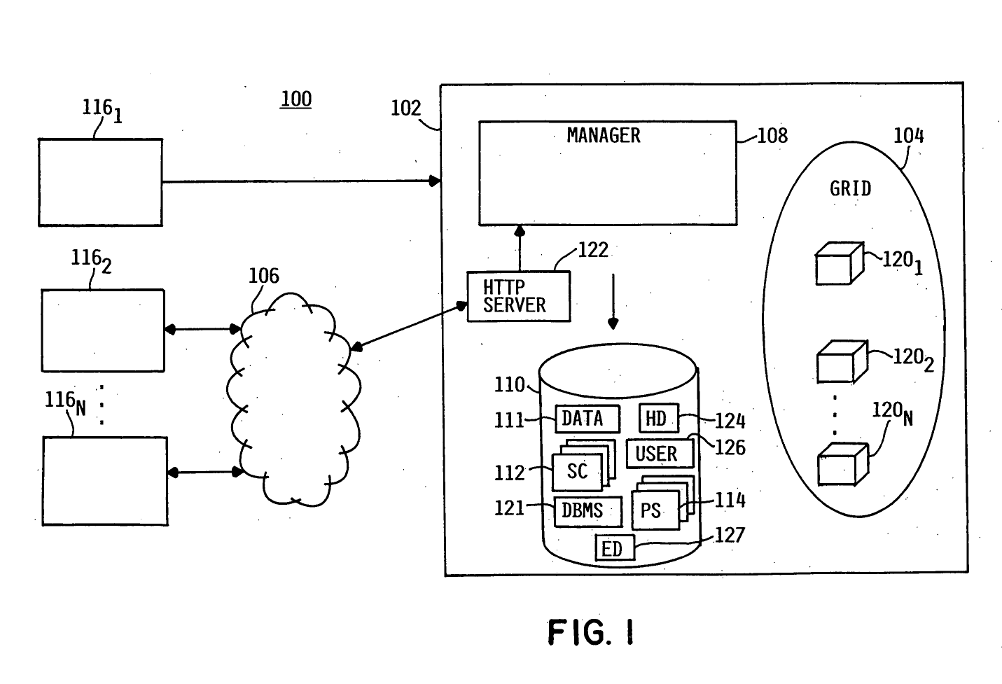

Referring now to FIG. 1, a data processing environment 100 is illustrated in which the present invention is practiced. Generally, the data processing environment 100 includes a provider computer system 102 and a plurality of one or more computer systems 116₁-116_{N} (collectively 116). The provider computer system 102 may be illustratively embodied as a server computer with respect to the system users' (client) computer systems 116. Although all computers are illustrated as singular entities, in practice the provider computer system 102 and the client computer systems 116 may all be a network of computers configured to perform various functions, including those described herein. Further, the terms “client” and “server” are utilized merely for convenience and not by way of limitation. As such, the users' computer systems 116, which may be clients relative to the provider computer system 102, in some regards, may themselves be servers relative to one or more other clients (not shown).

The provider computer system 102 and the computer systems 116 communicate through a network 106. The provider computer system 102 provides access to a grid computing environment or system 104. Access to various resources within the grid computing environment or system may also be provided by different service providers (not shown). The grid computing environment or system 104 may contain a plurality of different computing resources 120₁-120_{N} (collectively 120). The grid computing environment or system 104 may include parallel and distributed computing systems that enable sharing, selection, and aggregation of geographically distributed resources at runtime depending on their availability, capability, performance, cost, and/or user's quality of service requirements. The grid computing environment or system 104 may be a network including diverse hardware and/or software computing resources. These resources may be available and accessible through a network medium such as, the Internet, to a wide variety of users and may be shared between them.

In an exemplary embodiment, the network 106 may be any one of several suitable networks through which information may be transferred, such as, a local area network (LAN), or a wide area network (WAN), or the like. The provider computer system 102 may be configured using a hypertext transfer protocol (HTTP) server 122 for servicing requests from browser programs residing on the computer systems 116. The HTTP server 122 and the browser programs provide convenient and well-known software components for establishing a network connection (e.g., a TCP/IP connection) via the network 106. The network may include portions of a web services environment.

Referring back to the provider computer system 102, it may be configured by using a manager 108 that requests grid resources for the computer systems 116. In an exemplary embodiment, the manager 108 manages routing requests for education plans from the computer systems 116 to the appropriate resources of the grid computing system. Such a grid computing environment or system is described in copending and commonly assigned patent application Ser. No. 10/659,976 filed on May 2, 2003, and is incorporated herein by reference and made a part hereof. Some of the requests may be fulfilled on a fixed fee basis or a fee basis dependent on at least a parameter (e.g., time), whereby fees may be charged dependant on the time needed to process, for example a batch program request and/or return a response. The manager 108 also monitors progress of the requests by keeping track of time spent on a particular request and calculating an estimated cost of processing. Although, the manager 108 is shown as a single entity, it should be noted that it may be representative of different functions implemented by different software and/or hardware components within the provider computer system 102. The pricing of the processing costs for an education plan may be determined with respect to any variety of pricing criteria. Included in such criteria, for example, may be time-based criteria, request-type or class criteria, priority criteria, historical information, system user identification criteria, and combinations thereof. These pricing criteria may be applied to define pricing schedules that the manager 108 may access to calculate a cost for a request. In one embodiment, the pricing criteria are defined in service contracts (SC) 112 stored in a database 110. The database 110 may utilize a database management system (DBMS) 121, such as DB2™, that is commercially available from International Business Machines Corporation, Armonk, N.Y. The database 110 may also contain historical data (HD) 124, which may include a history of previous requests for education plans that are received and processed in the past, with the corresponding amount of resources utilized and the time taken to process various aspects of the programs. A service contract (SC) may exist for each contractual system user of the provider computer system 102 (i.e., each system user with whom the provider computer system 102 has entered into a legal agreement). In another embodiment, pricing criteria may be specified in generic pricing schedules (PS) 114 for system users who do not have contractual agreements with the service provider. Different generic pricing schedules (PS) 114 may exist for a variety of different pricing criteria including those mentioned above.

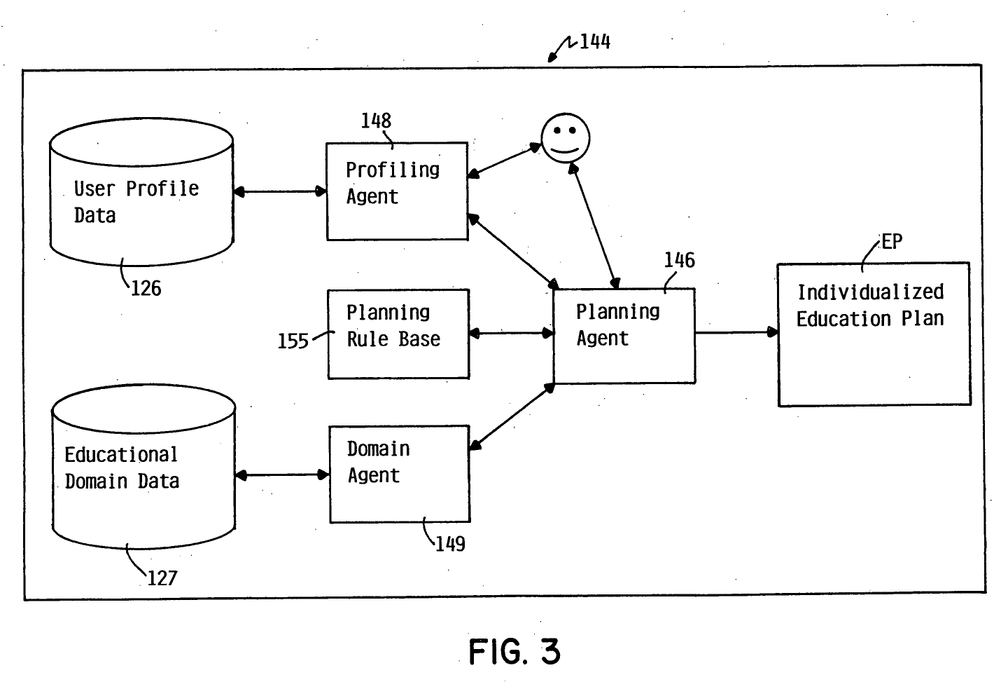

The historical data (HD) 124 may be searched to determine whether a similar or same request as the request being considered has been processed in the past. If a same or similar request is located in the historical data 124, then the information about the education resources as well as resources utilized, time, and costs taken to process the education plan may be used to select resources for effecting different education plans. Of course, each of the criteria mentioned above are optional, and may or may not be utilized in determining pricing and resource allocation schedules. Also included are a user profile (USER) database 126 and an educational domain database (ED) 127. The user profile database 126 stores data acquired from the user after being acquired by a profiling agent 148 (see, FIG. 3). The educational domain database 127 stores data acquired from the data mining of a domain agent 149 (see, FIG. 3).

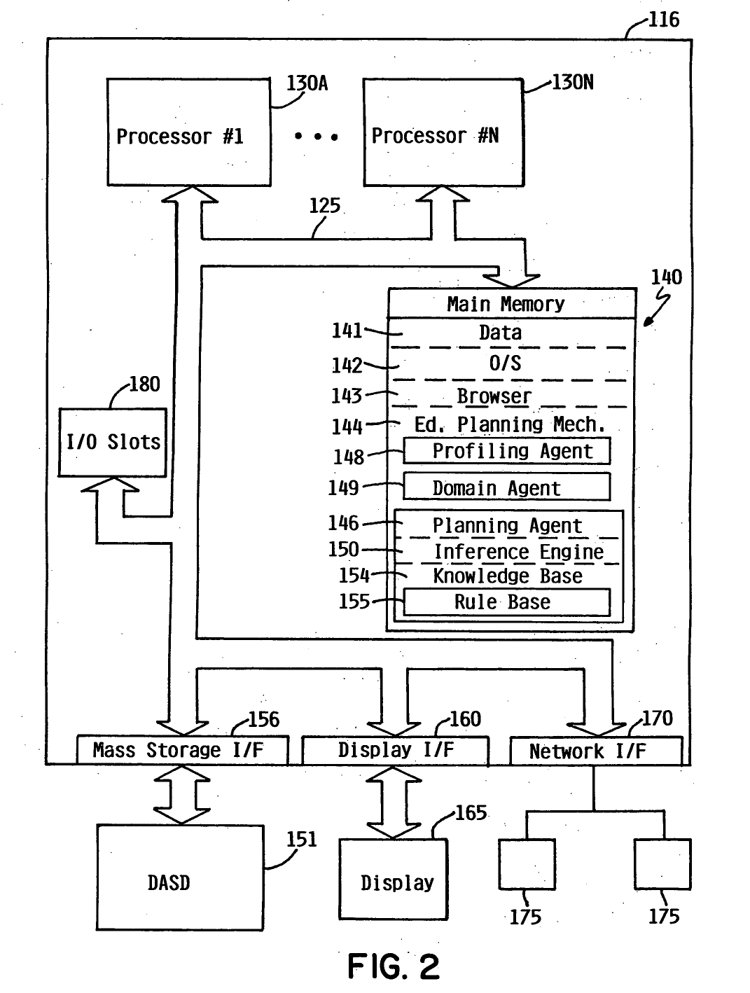

Reference is made to FIG. 2 for illustrating a computer system 116, such as an eServer iSeries® computer system commercially available from International Business Machines Corporation, Armonk, N.Y. It will be appreciated that other computer systems are envisioned for use in implementing the present invention and that the illustrated embodiment is exemplary of but one. The computer system 116 comprises one or more processors 130a-n (collectively, 130) that are connected to a main memory 140, a mass storage interface 156, a display interface 160, a network interface 170, and a plurality of I/O slots 180. A system bus 125 interconnects these components. Although only a single bus is illustrated, those skilled in the art will appreciate that the present invention may utilize multiple buses. Each one of the processors may be constructed from one or more microprocessors and/or integrated circuits. The processors execute program instructions in the main memory. The mass storage interface 156 is utilized to connect to mass storage devices, such as a direct access storage device (DASD) 151, for example a suitable CD RW drive, to a computer system. The display interface 160 is utilized to directly connect one or more displays 165 to the computer system 116. The displays 165 may be non-intelligent terminals or fully programmable workstations. The network interface 170 is utilized to connect other computer systems and/or workstations 175 to the computer system 116 across the network 106. It is pointed out that the present invention is applicable no matter how many computer systems and/or workstations may be connected to other computer systems and/or workstations and regardless of the network connection technology that is utilized.

The main memory 140 contains data 141 that may be read or written by any of the processors 130 or any other device that may access the main memory. The main memory 140 may include an operating system 142, an education planning mechanism 144. The main memory 140 stores programs and data that the processor may access and execute. The operating system 142 may be a multitasking operating system, such as i5/OS™, AIX™, Linux™, or other suitable kind(s). Those skilled in the art will appreciate that the spirit and scope of the present invention are not limited to any one operating system(s). The operating system 142 includes applications for operating the system including a browser application 143.

As better illustrated in FIG. 3, the education planning mechanism 144 includes an education planning agent 146, a profiling agent 148, and, a domain agent 149. An inference engine 152 and a knowledge base 154 containing a planning rule base 155 are included in the planning agent 146.

To provide for interaction with a user, the invention can be implemented on a computer system having a display device, such as a monitor or LCD screen for displaying information to the use, a keyboard, and a pointing device, such as a mouse or a trackball, by which the user can provide input to the computer system. The computer system can be programmed to provide a user interface, such as a graphical user interface through which computer programs interact with users.

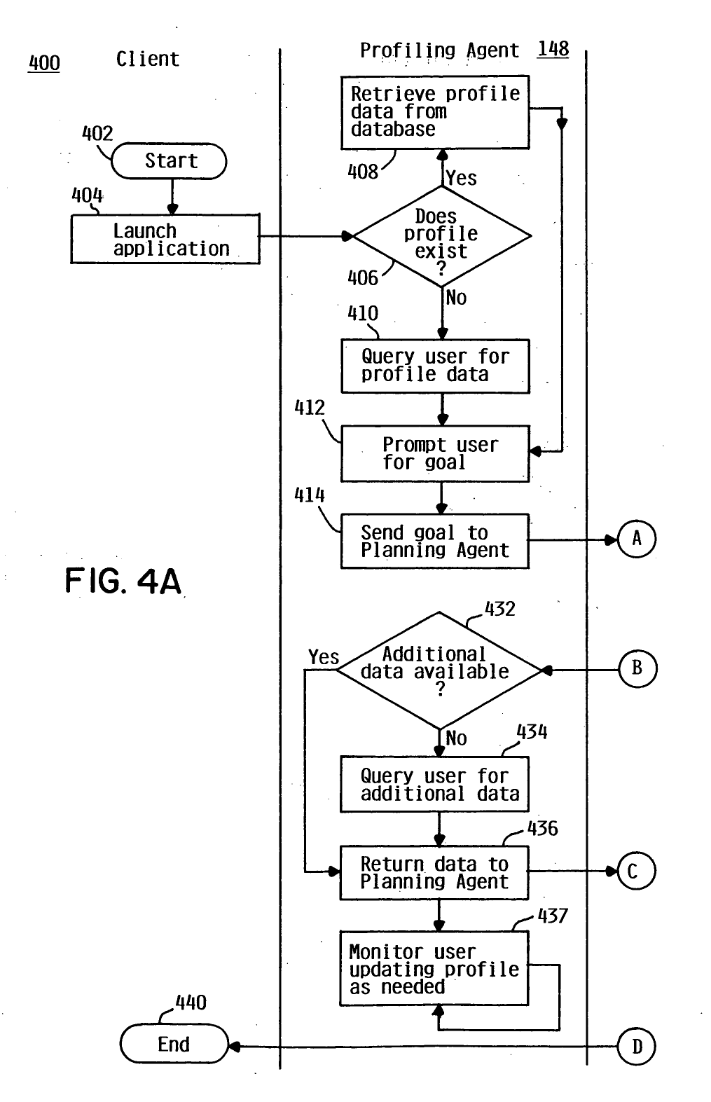

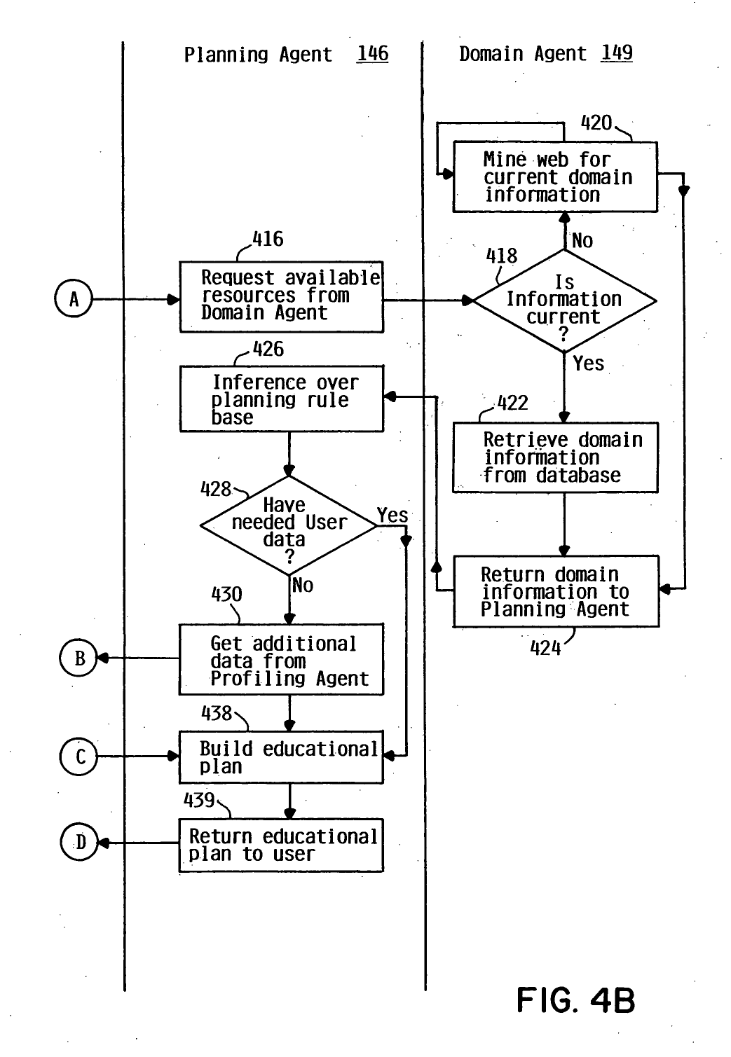

Exemplary steps of an education planning method 400 of the present invention are illustrated in FIGS. 4A-4B. The education planning method 400 is essentially implemented by the data processing system 100 and the education planning mechanism 144. The education planning method 400 provides for dynamically developing education plans responsive to the preferences and/or constraints of users even if the education resources have changed.

FIGS. 4A & 4B illustrate exemplary aspects of the education planning method 400 for dynamically developing education plans and starts in Start block 402 (FIG. 4A). As such, the education planning mechanism 144 is launched in a Launch block 404, by the client's browser application 143. After the launch, the steps in a Does User Profile Exist decision block 406 are performed. Basically, the decision block 406 is under the control of the profiling agent module 148 which searches the databases for a matching user profile in the databases. When there is a match, the decision is affirmative (i.e., Yes), and the education planning method 400 then proceeds to the Retrieve Profile Data from Database(s) block 408. In the block 408, all relevant specific user profile data related to the specific requesting user are retrieved. From the Retrieve Profile Data from Database(s) block 408 the education planning method proceeds to the Query User for Goals data block 410. Alternatively, when there is no match, the decision in the block 406 is negative (i.e., No), and the education planning method 400 proceeds to a Query User For profile data block 410.

In the Query User For Profile Data block 410, the profiling agent module 148 queries the requester or user for data that will assist in developing an education goal(s). For example, the profiling data may include job title, education level, or preferences and/or constraints with respect to course formats. Course formats may include known offerings, such as face-to-face, on-line, individualized, web-based, self-paced, and the like. The next steps performed in the education planning method 400 are to prompt the user for goal(s) in a Prompt User for Goal(s) block 412. In particular, the Profiling Agent module 148 prompts the requesting user for the requested goal(s) through any suitable user interface, such as a graphical user interface (GUI). Thereafter, the education planning method 400 transmits the user's education goal(s) to the Send Goal to Planning Agent block 414 to a Request Available Education Resources from Domain Agent block 416 (FIG. 3B). Basically, algorithms of the planning agent module 146 operate to extract information from the available education resources (e.g., web-based, face-to-face, etc.) under the control of the domain agent module 149. A task of the domain agent module 149 is to utilize the user's preferred domains of interest for searching. These preferences and/or constraints may be based on keyword(s) or the like, such as identified in the user's education goal(s). The domain agent module 149 controls one or more search engines including internet search engines for searching databases and the Internet. Searching of categories and the indices within each category of the domain of interest may be weighted or ranked to reflect the user's preferences for the particular domains of interest. In regard to the Internet, intranet or other similar network, the domain agent module 149 may control suitable search engine(s) and crawler(s) for searching and extracting information relating to the user's predefined categories. Accordingly, appropriate education resources from several different categories may be extracted, ranked, and stored in the user's educational domain database 126. Once the available education resources have been extracted and stored, then the steps in Is Information Current decision block 418 are performed under control of the domain agent module 149.

In the Is Information Current decision block 418, determinations by suitable algorithms are made as to whether the extracted education domain data are current. For example, the identified relevant categories, such as individualized resources, web-based resources, or group based resources, etc., may not be utilized because their usefulness falls out of acceptable range(s) of what may be considered current. Examples of these may occur when the resources are no longer available, the information or the course content changes and the like. When the decision in the Is Information Current block 418 is negative (i.e., No), then the steps in a Mine Web for Current Domain information block 420 are performed, whereby the domain agent module 149 performs data mining using any one(s) of a variety of known mining techniques. For example, a suitable web search engine may be utilized to gather the current information from indices on the web and the databases. Then the mined information is returned to a Return Domain Information to the Planning Agent block 424 by the Domain Agent module 149. Alternatively, when the decision is affirmative (i.e., Yes) in the Is Information Current block 418, then appropriate search algorithms are used. Accordingly, the domain information is retrieved from appropriate database(s) as well as the Internet. This is done in the Retrieve domain information from database block 422.

Thereafter, the education planning method 400 proceeds to a Return Domain Information to Planning Agent block 424, whereby the gathered domain information from the block 422 is transferred to the Inference over Planning Rule block 426 under the control of the planning agent module 146.

In the Inference over Planning Rule Base block 426, the inference engine or mechanism 150 is utilized. Basically, the inference engine 150 may be operated by one or more inference algorithms. The inference algorithms may be applied on the dynamic set of aggregated information acquired previously. The inference engine 150 enables disparate information sources to be collated, compared and queried. Then it is responsible for returning results of the query to the user through the GUI. The algorithms that are used for inferencing in this embodiment may be of the forward-chaining type that can navigate through the retrieved domain data to deduce results which may be used for arriving at an education plan (EP). The inference algorithms may be utilized in combination with the planning rule base (PRB) 155 for establishing education plans. The knowledge base may be a planning rules base comprising a set of if/then rules. The rules do a sort of generalized questions. In this embodiment, an example of the several questions may include: do prerequisite skills match some scheduled courses which match learning preferences and/or constraints.

Then the education planning method 400 proceeds to the Have Needed Decision User Data decision block 428. In the decision block 428, steps are performed, whereby a suitable algorithm(s) makes a determination of whether sufficient data is present for satisfying the requested data for in the education plan that is to be developed as deduced from the Inference over Planning Rule Base block 426. Referring to the decision block 428, if there is the needed data (i.e., Yes), for the education plan, then the next step in the education planning method 400 follows. In particular, steps of the Build Education Plan block 438 are performed next for building the education plan. In the Build Education Plan block 438, the requested information plan is built. It is built through the application of known plan building algorithms using the inference algorithms and planning rule base 155. Accordingly, an education plan is developed that meets the preferences and/or constraints of the user and is responsive to current information that is available from the databases and the Internet.

When the decision in the Have Needed Data User decision block 428 is No, that the needed data is unavailable to complete the education plan, then the education planning method 400 proceeds to the Get Additional Needed Data from Profiling Agent block 430. In the Get Additional Data from Profiling Agent block 430, suitable algorithms under the control of the planning agent module 146 operate to search for the missing or additional data. This may be accomplished through the application of suitable search tools to the databases and the Internet in the Is Additional Data Available decision block 432. If additional data are unavailable (i.e., NO) as determined by suitable search tools, then the user is queried for the additional data in the Query User for Additional Data block 434. The user supplies the Additional Data, for example, scheduling preferences, course preferences, etc. Thereafter, in a Return Data to Planning Agent block 436 the complete set of data is returned to the planning agent module by the profiling agent module. From the block 436, the complete information is sent to the Build Education Plan block 438. It will be noted that a Monitor User Updating Profile as Needed block 437 may follow in which the process periodically checks for user profile updates based on user behavior or feedback. If the user profile is updated then that data will be used for subsequent queries in the profile data for use in the block 410. Alternatively, if the additional data is available in the decision block 432 (i.e., Yes), then the complete set of information is forwarded to the Return Data to Planning Agent block 436. From the block 436, such information is sent to the Build Education Plan block 438. The Build Education Plan block 438 operates to build or develop an education plan based on the aggregated information in combination with the inference engine and the planning rule base 155. As such the education plan may be communicated to the user through the GUI. Thereafter, the education planning method 400 ends in the End block 436.

It will, therefore, be appreciated that the present invention provides an improved system, and method for developing educational plans responsive to user preferences and/or constraints.

One aspect of the invention is implemented as a program product for use with a computer system or environment. The program(s) of the program product defines functions of the embodiments (including the methods described herein) and may be contained on a variety of signal-bearing media. Illustrative signal-bearing media include, but are not limited to: (i) information permanently stored on non-writable storage media (e.g., read-only memory devices generally within a computer such as CD-ROM disks readable by a CD-ROM drive); (ii) alterable information stored on writable storage media (e.g., floppy disks generally within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature utilized is merely for convenience. Thus, the invention should not be limited to use solely in any specific application identified and/or implied by such nomenclature.

This invention could be implemented in an industry setting to dynamically develop education plans for employees in a company. For example, assume an employee is a software engineer with a degree in computer science, and she wishes to learn how to program in Java. The employee could invoke the educational planning application via her web browser using the company's intranet. She would enter a user id and password to log on to the system. The profiling agent would search the user profile database to find the employee's record. For this example, assume that the profile exists and contains the employee's educational background and indicates that the employee prefers self-paced or web-based education. If the profile did not exist, the employee would be prompted to enter the required information.

The profiling agent would then prompt the employee for her educational goal. In this case, the employee may indicate that she wants to become a certified Java programmer. This goal would be sent to the planning agent who would, in turn, pass the goal on to the domain agent. The domain agent would then search the company intranet, the company course database, and the Internet for courses that result in the knowledge required to become a certified Java programmer. The domain agent would determine if courses found are appropriate to meet the employee's educational goal. Relevant courses would be returned to the planning agent.

The planning agent would then use the information returned by the domain agent, along with its knowledge base to build an educational plan for the employee. The rules in the planning agent's knowledge base would include rules regarding scheduling, course format, course sequence, and learner preferences. These would be used to build an education plan that is individualized for the employee. For example, the courses may include an introduction to Java course that is web-based but lists object-oriented programming as a prerequisite. The planning agent's rules would determine whether the course should be added to the plan based on whether the employee's profile indicated she had object-oriented programming skills. If the employee did not have that skill, the profiling agent could again query the domain agent for object-oriented programming courses that could be included in the plan.

Then, as the employee progressed through the courses in the plan, the profiling agent would update the employee's profile to reflect the courses taken as well as any change in preferences the employee may have.

The embodiments and examples set forth herein were presented to explain best the present invention and its practical applications, thereby enabling those skilled in the art to make and use the invention. However, those skilled in the art will recognize that the foregoing description and examples have been presented for the purposes of illustration and example only. The description set forth is not intended to be exhaustive or to limit the invention to the precise forms disclosed. In describing the above-exemplary embodiments illustrated in the drawings, specific terminology has been utilized for the sake of clarity. However, the invention is not intended to be limited to the specific terms selected. It is to be understood that each specific term includes all technical equivalents that operate in a similar manner to accomplish a similar purpose. Many modifications and variations are possible in light of the above teachings without departing from the spirit and scope of the appended claims.

What is claimed is:

1. A computer-implemented method of developing education plans comprising: providing a planning manager residing in a memory for dynamically developing an education plan responsive to user preferences and/or constraints.

2. The method of claim 1 further comprising developing an education plan based on data inferenced by an inference engine.

3. The method of claim 2 further comprising coupling a knowledge base to the inference engine for inferencing data including education domain data, and user profile data, whereby an education plan can be returned.

4. The method of claim 2 further comprising profiling user preferences and/or constraints by querying users through a user interface.

5. The method of claim 2 further comprising searching and mining education domain data that is retrieved from searches by a domain agent.

6. The method of claim 3 further comprising learning unstated preferences and/or constraints by the inference engine.

7. A program product comprising: a planning manager that dynamically develops an education plan responsive to user preferences and/or constraints; and, a computer readable signal bearing media bearing the planning manager.

8. The program product of claim 7 wherein the planning manager includes an inference engine for developing an education plan, and a planning rule base coupled to the inference engine for inferencing data adapted to be developed into an education plan.

9. The program product of claim 7 wherein the planning manager includes a profiling mechanism for developing user profile data by querying users.

10. The program product of claim 9 wherein the planning manager includes a domain agent for conducting searches and mining education domain data that is retrieved from the searches based of the domain agent.

11. The program product of claim 8 wherein the inference engine monitors users for learning unstated preferences and/or constraints.

12. An apparatus comprising: at least one processor; a memory coupled to the at least one processor; and, a planning manager residing in the memory for dynamically developing an education plan responsive to user preferences and/or constraints.

13. The apparatus of claim 12 wherein the planning manager includes an inference engine for developing an education plan based on education domain data.

14. The apparatus of claim 13 wherein the planning manager includes a planning rule base coupled to the inference engine.

15. The apparatus of claim 12 wherein the planning manager the inference engine monitors users for learning unstated preferences and/or constraints.

16. The apparatus of claim 12 wherein the planning manager includes a domain agent for conducting searches and storing education domain data that is retrieved from the searches.

17. A computer-implemented method of developing education plans comprising: providing a planning manager residing in a memory for dynamically developing an education plan responsive to user preferences and/or constraints; developing the education plan based on data inferenced by an inference engine; coupling a knowledge base to the inference engine for inferencing data including education domain data, and user profile data, whereby an education plan can be returned; profiling user preferences and/or constraints by querying users through a user interface; searching and mining education domain data that is retrieved from searches by a domain agent; and, learning unstated preferences and/or constraints by the inference engine.

18. A program product comprising: a planning manager that dynamically develops an education plan responsive to user preferences and/or constraints; and, a computer readable signal bearing media bearing the planning manager; wherein the planning manager includes an inference engine for developing an education plan, and a planning rule base coupled to the inference engine for inferencing data adapted to be developed into an education plan; wherein the planning manager includes a profiling mechanism for developing user profile data by querying users; wherein the planning manager includes a domain agent for conducting searches and mining education domain data that is retrieved from the searches based of the domain agent; wherein the inference engine monitors users for learning unstated preferences and/or constraints.

19. An apparatus comprising: at least one processor; a memory coupled to the at least one processor; and, a planning manager residing in the memory for dynamically developing an education plan responsive to user preferences and/or constraints; wherein the planning manager includes an inference engine for developing an education plan based on education domain data; wherein the planning manager includes a planning rule base coupled to the inference engine; wherein the planning manager the inference engine monitors users for learning unstated preferences and/or constraints; wherein the planning manager includes a domain agent for conducting searches and storing education domain data that is retrieved from the searches.

20. A computer-implemented method of providing education planning services to one or more users, the method comprising: dynamically developing an education plan by a planning manager residing in memory and responsive to preferences and/or constraints of a user.

21. The method of claim 20 further comprising developing the education plan based on data inferenced by an inference engine.

22. The method of claim 21 further comprising coupling a knowledge base to the inference engine for inferencing data including education domain data, and user profile data, whereby the education plan can be returned.

23. The method of claim 22 further comprising profiling user preferences and/or constraints by querying users through a user interface.

24. The method of claim 23 further comprising searching and mining education domain data that is retrieved from searches by a domain agent.

25. The method of claim 23 further comprising learning unstated preferences and/or constraints by the inference engine.
